(19) United States
(12) Patent Application Publication
(10) Pub. No.: US 2010/0116713 A1
(43) Pub. Date: May 13, 2010

(54) Ionic liquid catalyst for the improvement of heavy crude and vacuum residues

(75) Inventors: Felipe de Jesús Ortega García, Delegacion Gustavo A. Madero (MX); Persi Schacht Hernández, Delegacion Gustavo A. Madero (MX); Marco Antonio Ramírez Garnica, Delegacion Gustavo A. Madero (MX); Natalya Victorovna Likhanova, Delegacion Gustavo A. Madero (MX); Joaquín Rodolfo Hernández Pérez, Delegacion Gustavo A. Madero (MX); Ricardo Jesús Ramírez López, Delegacion Gustavo A. Madero (MX)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: INSTITUTO MEXICANO DEL PETROLEO, Mexico City (MX)

(21) Appl. No.: 12/463,696

(22) Filed: May 11, 2009

(30) Foreign Application Priority Data
May 9, 2008 (MX) MX/A/2008/006051

(51) Int. Cl. B01J 23/755; B01J 23/28

(52) U.S. Cl. 208/121; 502/313; 502/315; 502/316

(57) ABSTRACT

Heavy crude oil residue and vacuum residue is upgraded using an ionic liquid catalyst formulated with metals of Group VIB and VIIIB of the periodic table, which catalyst is highly miscible in the hydrocarbon phase. The combination of different metals and acidity from the protons that make up the ionic liquid breaks the links C—S, C—N and C—O of the resins and asphaltenes and increases API gravity, decreases viscosity, removes sulfur and nitrogen compounds, and results in conversion of 50 to 70% of the waste oil and heavy crude oil into lighter distillates.

### CROSS-REFERENCE TO RELATED PATENT APPLICATION

This application claims the priority to Mexican Patent Application No. MX/a/2008/006051, filed on May 9, 2008, in the Mexican Patent Office, the disclosure of which is hereby incorporated by reference in its entirety.

### DESCRIPTION

1. Technical Field of the Invention

The present invention is related to a promoted ionic liquid catalyst with metals of the group VIB and VIIIB of the periodic table for the improvement of heavy crude oil and vacuum residues in the production of light and intermediate distillates, obtaining a crude oil of less viscosity and major gravity API. The ionic liquid catalyst is highly miscible in hydrocarbon and it is in homogenous phase.

2. Background of the Invention

In the next few years in Mexico, some of the untapped natural resources shall consist mainly of heavy crude oil, this means that the industry of oil refining, generate greater quantities of waste, which must be exploited to transform it into distillates higher commercial value.

One of the most abundant residues from refining of petroleum, vacuum residue, which is seen as a cheaper alternative for the replacement of traditional fuels (natural gas, diesel and fuel oil) used in generating electricity, the after being released for obtaining distilled.

If only considering the use of vacuum residue for the oil sector, it should be noted that the Institute of Electrical Research (IER), has conducted research projects on the use of emulsions to enable it to employ Federal Electricity Commission (FEC), this type of waste, which would lead to a decrease of costs incurred by this company during the production process, in addition to further diversify the type of energy it uses.

Furthermore, it is estimated that the average yield of vacuum residue in the period 2009-2012 will be 52.5 mbd (Thousand barrels per day), representing an average increase of 10%.

In Table 1, the relation can be observed that will keep the totals of supply and oil demand, that is to say, private consumption of the Mexican sector, and that will be equal to its production in the study horizon.

TABLE 1
National balance of vacuum residues 2009-2012
(Thousands of daily barrels)

| Concept | 2009 | 2010 | 2111 | 2012 |
|---|---|---|---|---|
| Total supply | 42.1 | 56 | 56 | 56 |
| National Production | 42.1 | 56 | 56 | 56 |
| Cadereyta | — | — | — | — |
| Madero | — | 13.5 | 13.5 | 13.5 |
| Tula | 14.3 | 14.3 | 14.3 | 14.3 |
| Salamanca | 14.3 | 14.3 | 14.3 | 14.3 |
| Salina Cruz | 13.5 | 13.9 | 13.9 | 13.9 |
| Total demand | 42.1 | 56 | 56 | 56 |
| Internal demand | 42.1 | 56 | 56 | 56 |
| Consumption of PEMEX | 42.1 | 56 | 56 | 56 |

There have been impressive advances in recent years in the hydroprocessing waste, both in process technology and catalysts. SFA Pacific estimated that about 50% of all waste used in hydrotreating processes for the preparation of food. Since 1990, the use of catalytic processes has been extended to process the waste. The methods most commonly used are: bed and fixed bed boiling.

The capacity installed for the processing of residues is of 450.000 b/d world-wide for Kellogg ROSE and UOP, the processes of Demex. Kellogg has made modifications internal recently. The IFP has their own system of without-asphalt with reliable critic, the process of Solvahl. SFA Pacific projects that the without-asphalt one with reliable will have an expansion with visbreaking. The without-asphalt one with reliable also projects for the use in combination with slowed down coker.

On the other hand, in the world there are large deposits of heavy crude oils and extra-heavy, which have low API gravity, viscosity and high concentrations of heteroatoms of sulfur, oxygen, nitrogen, aromatics and nickel porphyrins, iron and vanadium, contaminants contained primarily in resins and asphaltenes. The high concentration of these compounds in crude implies a low yield in the distillable fraction (gasoline, turbosina, kerosine and diesel fuel), which has represented a challenge of great importance for the refining industry and has encouraged the emergence of different outlines the process to use the bottom barrel, once removed from the sites.

On the matter, it is desirable to have processes of treatment of the crude one within the deposit (in-situ), by means of highly soluble catalysts in the crude oil, which glimpses like a newness, in view of which the same deposit can provide the conditions of operation partially required to improve its quality (high pressure and stops times of residence).

The following literature concerns the treatment of waste, such as heavy crude oil and bitumen.

FAN Hong-fu*, LI Zhong-bao, Liang Tao J Fuel Chem Technol, 2007, 35(1), 32 .35, Journal of Fuel Chemistry and Technology, Volume 35, Issue 5, October 2007, Pages 558-562, carried out a study using liquid ionic for the crude improvement of heavy. One diminishes viscosity, the molecular weight average and the content of asphaltenes. They propose a mechanism of reaction between the ionic liquid and the crude one, reason why the transition metal improves the oil and avatar viscosity.

Zou et al discusses the core of the reaction for the catalytic degradation of macromolecular asphaltenes. They found that the ionic liquid with a system that contains H₃PO₄ was effective for the asphaltenes compound degradation. Gu at al discusses the application of ionic liquids in the petrochemical one and catalytic processes, also studied the catalytic degradation CD (polycarbonate compact discs) with ionic liquids and the results indicate that the main degradation product was diphenyl.

Otto P. studied the disintegration of bitumen with superacid catalysts enabling chemical changes through effects aliphatic average reaction conditions, resulting in high yields of volatile compounds and liquid products in contrast to the conventional catalyst hydrocracking which is the mechanism of free radicals.

U.S. Pat. No. 5,578,197 dated Nov. 26, 1996, refers to the residue hydrodisintegration heavy crude oil with high concentrations of asphaltenes. This patent uses an additive from metallic compounds such as iron pentacarbonyl or 2-ethyl hexanoate molybdenum, which prevent the formation of coal, which is generated during the hydrodisintegration and are useful for hydrotreating residue hydroconversion conditions typical of waste in a batch reaction system.

U.S. Pat. No. 5,362,382 dated Nov. 8, 1994, talks about to the hydrotreating of petroleum remainder using a dispersed metallic catalyst in the remainder, in a process of two steps, in which the catalyst is selected between hexacarbonyl of molybdenum, naphthenate of molybdenum or naphthenate of nickel to reduce the coal formation in the process.

U.S. Pat. No. 7,001,504 B2 dated Feb. 21, 2006 for “Process for organosulphur the hydrocarbon compound removal”, refers to a process by contacting an ionic liquid hydrocarbon for more extraction of sulfur compounds. The low-sulfur gasoline to values of 1000 ppm. The ionic liquid is made from ethyl methyl imidazole and two variants with a hexafluorofosfato and teracloaluminato

U.S. Pat. No. 6.540.904 dated Apr. 1, 2003, claims a process for upgrading heavy residue in the presence of a solvent and a catalyst of ferrous sulfate.

U.S. Pat. No. 4,455,218 dated Jun. 19, 1984, makes reference to a process of hydrogenation of bitumenes with catalysts derived from Fe₂(CO)₉ to increase the yield of distillates, it is not applied for the heavy and extra-heavy oil improvement crude with Fe(CO)₅. The concentrations of the used catalyst are of 1.1% in weight.

U.S. Pat. No. 4,863,887 dated Sep. 5, 1989, demands the improvement of vacuum residues by means of heteropolyacids molybdenum catalysts with a concentration of 2,500 ppm weight with 5.6% in weight of water.

U.S. Patent Publication No. 2004/0031726 dated Feb. 19, 2004, makes reference to a process for the improvement of heavy crude, by processing conditions of conversion of residues in the presence of a generating compound of free radicals and a hydrogen donor, where the generator of free radicals promotes the reactions to form distillates, and the hydrogen donor inhibits the reactions of coal formation.

“Experimental study on using ionic liquids to upgrade heavy oil”, FAN Hong-fu*, LI Zhong-bao, Liang Tao J Fuel Chem Technol, 2007, 35(1), 32 .35, Journal of Fuel Chemistry and Technology, Volume 35, Issue 5, October 2007, Pages 558-562

“Catalytic degradation of macromolecule constituents of asphaltic sand in ionic liquids” Ming L I, Ji-qian WANG, Wen-an DENG and Guo-he Zou C. J. Liu C. Luo P. Y. Journal of Chemical Industrial and Engineering (China), 2004. 55(12): 2095-2098

Gu Y. L. Deng Y. Q. Study and application of RTILs in petrochemical catalysts. Petrochemical Technology & Application, 2002, 20(2); 73-78.

“Upgrading of Alberta's Heavy Oils” by Superacid-Catalyzed Hydrocracking, Otto P. Strausz, Thomas W. Mojelsky, and John D. Payzant Chemistry Department, University of Alberta, Edmonton, AB T6G 2G2, Canada George A. Olah and G. K. Surya Prakash Hydrocarbon Research Institute, University of Southern California, Los Angeles, Calif. 90089-1661 Energy & Fuels 1999, 13, 558-569.

### SUMMARY OF THE INVENTION

The present invention improves the quality of heavy crude oil and vacuum residue, through incorporation of ionic liquid catalysts, resulting in increases in API gravity, lower viscosity, weight average and the molecular content of asphaltenes, as well as a significant change in chemical composition. The present process results in hydroconversion reactions of asphaltenes and resins to higher value added products such as gasoline, distillates and gas oils, as well as a reduction in the content of sulfur and nitrogen compounds, which is surprising.

All the previous references are surpassed by the present invention, which provides the development of ionic liquid catalysts to base transition metals which they allow to operate under process scheme to break hydrocarbon chains of high molecular weight by ionic mechanisms or free radical under conditions of pressure and temperature of the existing processes in the refineries.

Thus, heavy crude oil residue and vacuum residue is upgraded using an ionic liquid catalyst formulated with metals of Group VIB and VIIIB of the periodic table, which catalyst is highly miscible in the hydrocarbon phase. The combination of different metals and acidity from the protons that make up the ionic liquid breaks the links C—S, C—N and C—O of the resins and asphaltenes and increases API gravity, decreases viscosity, removes sulfur and nitrogen compounds, and results in conversion of 50 to 70% of the waste oil and heavy crude oil into lighter distillates.

### DETAILED DESCRIPTION OF THE INVENTION

The present invention relates to improving heavy crude oil and vacuum residue through the hydrocracking and hydrogenation reactions of molecules of asphaltenes and resins. Experimental results reveal improvement of vacuum residues through the treatment with liquid promoted metal ions from Group VIB and VIIIB of the periodic table, such as Co, Zr, Ni, Mo, Fe, preferably nickel and molybdenum. In one embodiment, nickel and molybdenum can be used in a 30:1 molar ratio. The ionic liquid catalyst is highly miscible in hydrocarbon, and they are in homogenous phase with the same.

The ionic liquid catalysts of the present invention are mixed with the hydrocarbon feed at room temperature, and do not require activation. The amount of ionic catalyst admixed with the feed may be, for example, between about 10 and about 5000 ppm, preferably between about 100 and 1000 ppm. The catalyst and feed are formed into a homogeneous mixture and then pressurized with hydrogen to at least 50 kg/cm². The mixture of heavy crude oil and/or catalytic residue and solution were evaluated in a batch reactor, for example, of 100 ml and 1800 ml capacity, pressurized with hydrogen at 50 to 150 kg/cm² at a temperature of 250-450° C. and residence times between 2 and 72 hours, resulting in the breakup of the molecules of asphaltenes and resins, as well as the removal of sulfur and nitrogen compounds. Roughly between 20 and 60% of the hydrocarbons in the waste were converted into lighter distillates and in the case of heavy crude oil was 30 to 70%.

The present invention increases the API gravity, decreases viscosity, and removes sulfur and nitrogen compounds from heavy crude oil and vacuum residue through a pattern of ionic liquids, which provide management, refining and enhancing its market value to reduced content of asphaltenes and resins are characterized by being strong with high levels of sulfur, asphaltenes and precursors for the formation of coal transformed these light hydrocarbons to higher value added.

The API gravity of heavy crude oil and vacuum residue, increased from 12° to 20° and from 1-5 to 7-13° respectively, and the viscosity decreased significantly.

### Preparation of Ionic Liquid Catalyst

The preparation of ionic liquid catalyst involves two stages, in the first stage a mineral acid solution is prepared by adding the mineral acid to water, the acid concentration should be 0.5-10 wt %, preferably 1-5 wt %; water should be heated at 30-100° C. preferably at 50-70° C. In the second stage the metal precursors are mixed in the form of sulfates, nitrates or phosphates among others and dissolved in the acid solution until a perfectly clear solution is obtained. The solution is aged for 24 hours after which it can be employed directly to promote hydrocracking and hydrogenation reactions. The catalyst of the present invention has high catalytic activity in hydrogenation and hydrocracking reactions of heavy crude oil and vacuum residues at temperatures between 250-420° C. and pressures from 50 to 150 kg/cm².

An alternative process for the preparation of ionic liquid catalyst involves two stages, in the first stage metal precursors are mixed in the form of sulfates, nitrates or phosphates among others, with hydrochloric acid, sulfuric acid or phosphoric acid conditions at temperatures between 15° C. and 80° C., preferably between 25° C. and 50° C., with agitation, until a perfectly clear solution is formed. In the second stage, water is added sufficient to obtain a water-precursor ratio of 1:1, preferably 1:0.4. At this stage, a transparent liquid solution is obtained that is employed directly in the process of hydrocracking and hydrogeneration. The precursor metal and acid heteropolyacid form a compound that in combination with the ammonium salt of this heteropolyacid with a molar ratio 30:1, so that the ion formed behaves like an anion and the ammonium group as a cation. The catalyst of the present invention has high catalytic activity in hydrogenation reactions and hydrocracking of heavy crude oil residue and vacuum residue at temperatures between 250-420° C. and pressures from 50 to 150 kg/cm².

The metals used in this invention are derived from groups VIB and VIIIB of the periodic table of elements with a 30:1 molar ratio, and are consistent with the hydrocarbon phase. These solutions are used in the range of 100 to 5000 weight ppm, preferably 10 to 1000 ppm weight.

### General Preparation.

Perfectly dissolve a salt containing a metal from group VIB in an acid solution containing a mineral acid such as phosphoric, sulfuric, hydrochloric or other acid previously heated at 30-100° C., preferably at 50-70′C. Add gradually a salt containing a metal from group VIIIB or IB, stir the solution continuously making sure it dissolves completely. Cool slowly at room temperature and age for 24 hours. The solution pH should be lower than 2, preferably lower than 1.0.

Example of the Preparation of the Catalyst

Add 48.1 g of deionized water in a flask, add 0.9 g of hydrochloric acid while stirring moderately and slowly heat at 65° C. In a mortar grind 0.7 g of ammonium heptamolybdate and add it to the acid solution, stir until the salt dissolves completely. Grind 50.3 g of nickelous sulphate in a mortar and add it gradually into the acid solution to obtain a homogeneous and clear solution. Cool lowly slowly at room temperature verifying that there is no precipitation. Age for 24 hours at room temperature and verify the pH is lower than 1.

The incorporation of the ionic liquid catalyst of the present invention is dispersed at the molecular level and promotes the disintegration of the asphaltene molecules through ionic mechanisms of reaction at temperatures between 250 and 420° C. and pressure of 50 to 150 kg/cm² to produce low molecular weight distillates. Furthermore, the combination of different metals and acidity from the protons that make up the ionic liquid is possible to break the links C—S, C—N and C—O of the resins and asphaltenes improve significantly the properties of heavy crude oil and vacuum residue.

### Examples

The following examples are presented to illustrate the behavior of the catalysts of this invention in improving heavy crude oil and vacuum residue, through the reactions and hydrogenation hydrocracking molecules of asphaltenes and resins. These examples should not be regarded as limitations, but simply report the best use of the ionic liquid catalyst and its evaluation in an appropriate manner in the present invention.

### Example 1

The load was heavy oil used KU-H in the region East of Campeche, Mexico, its properties is detailed in Table 2.

In a batch reactor with a capacity of 100 ml, were placed 65 g of crude KU-H and 1.0 g of ionic liquid catalyst made from Ni and Mo with a 30:1 molar ratio, were mixed homogeneously with pressurized hydrogen at 30 g/cm². The temperature of the atmosphere was increased until 395° C. being reached the pressure of 100 Kg/cm² in the system. Once stabilized the previous conditions the reaction time it was of 4 hours.

Table 2 shows the viscosities of the load and hydrotreated product, noting that under the conditions of hydroconversion previous crude KU-M significantly decreased the viscosity and increasing its API gravity of 12.6° to 20.6°.

Through the hydrotreating catalyst with ionic liquid based on Ni—Mo with a 30:1 molar ratio, there is an increase in saturated and aromatic hydrocarbons at the expense of conversion of resins and asphaltenes, which decreased from 16.81 to 13.0.2 and 28.65 to 12.62% by weight, respectively. Also notable is the reduction of sulfur from 5.14 to 3.8% by weight, so there is a removal of approximately 26% by weight. The total nitrogen was reduced from 750 to 330 ppm weight denitrogenation equivalent to 44% by weight.

TABLE 2
Properties of crude oil KU-H, loading and hydrotreated product with the
ionic liquid catalyst based on Ni—Mo with a 30:1 molar ratio (700 ppm
weight).

| Properties | | Loading | Product |
|---|---|---|---|
| Specific Gravity, ° API | | 12.6 | 20.6 |
| Viscosity, sCt | 15.6° C. | 16273 | 105 |
| | 25° C. | 5400 | 55 |
| | 37.8° C. | 1444 | 28.15 |
| Total sulfur, weight % | | 5.14 | 3.8 |
| Total Nitrogen, ppm weight | | 750 | 330 |
| SARA, % by weight | Saturates | 12.73 | 28.03 |
| | Polar | 16.81 | 13.02 |
| | Aromatic | 41.81 | 46.18 |
| | Asphaltenes | 28.65 | 12.62 |

### Example 2

The load was heavy oil used KU-H in the region East of Campeche, Mexico, its properties is detailed in Table 3.

In a batch reactor with a capacity of 100 ml were placed 65 g of crude KU-H and 0.9 g of ionic liquid catalyst made from Ni and Mo with a 30:1 molar ratio, were mixed homogeneously with pressurized hydrogen at 30 Kg/cm². The temperature of the atmosphere was increased until 395° C. being reached the pressure of 100 Kg/cm² in the system. Once stabilized the previous conditions the reaction time it was of 4 hours.

Table 3 shows the viscosities of the load and hydrotreated product, noting that under the conditions of hydroconversion previous crude KU-M significantly decreased the viscosity and increasing its API gravity of 12.6° to 18.87°.

TABLE 3
Properties of crude oil KU-H, hydrotreated with a catalyst-based ionic
liquid Ni—Mo with a 30:1 molar ratio (500 ppm weight).

| Properties | | Product |
|---|---|---|
| Specific Gravity, ° API | | 18.87 |
| Viscosity, sCt | 25° C. | 35.12 |
| | 40° C. | 22.58 |
| | 54.4° C. | 14.94 |
| Total sulfur, weight % | | 3.7 |
| Total Nitrogen, ppm weight | | 590 |
| SARA, % by weight | Saturates | 27.63 |
| | Polar | 12.64 |
| | Aromatic | 43.73 |
| | Asphaltenes | 16 |

Through the hydrotreating catalyst with ionic liquid was an increase in API gravity of 6 units, the viscosity decreased significantly to values below 35 cSt. The removal of sulfur was 28 wt % (5.13 to 3.7 wt %).

### Example 3

The load was heavy oil used KU-H in the region East of Campeche, Mexico, its properties is detailed in Table 2.

In a batch reactor with a capacity of 1200 ml, were placed 1000 g of crude KU-H, adding 15 grams of an ionic liquid-based catalyst of Ni and Mo with a molar ratio 30:1. The reaction was carried to 395° C. and 100 kg/cm² for 4 hours. The results are shown in Table 4.

TABLE 4
Properties of crude oil KU-H, product treated with ionic liquid catalyst
based on Ni and Mo with a 30:1 molar ratio (700 ppm weight).

| Properties | | Product |
|---|---|---|
| Specific Gravity, ° API | | 20 |
| Viscosity, sCt | 25° C. | 81.37 |
| | 40° C. | 47.2 |
| | 54.4° C. | 29.89 |
| Total sulfur, weight % | | 3.2 |
| Total Nitrogen, ppm weight | | 420 |
| SARA, % by weight | Saturates | 25.83 |
| | Polar | 13.64 |
| | Aromatic | 43.13 |
| | Asphaltenes | 17.4 |

### Example 4

The load was heavy oil used KU-H in the region East of Campeche, Mexico, its properties is detailed in Table 2.

In a batch reactor with a capacity of 1200 ml, were placed 1000 g of crude KU-H, adding 18 grams of an ionic liquid catalyst-based Ni—Mo. The reaction was carried to 395° C. and 100 kg/cm² for 4 hours. The results are shown in Table 5.

### Example 5

The load was heavy oil used KU-H in the region East of Campeche, Mexico, its properties is detailed in Table 2.

In a batch reactor with a capacity of 1200 ml, were placed 1000 g of crude KU-H, adding 10 grams of an ionic liquid-based catalyst of Ni and Mo with a molar ratio 30:1. The reaction was carried at 350° C. and 100 kg/cm² for 48 hours. The results are shown in Table 6.

### Example 6

The feed used was heavy vacuum residue from the refinery in Tula Hidalgogo, Mexico, its properties are detailed in Table 7.

In a Parr reactor with a capacity of 1800 ml was charged 1000 g of vacuum residue.

The reactor was pressured to 20 Kg/cm² with hydrogen and heated to 90° C. in order to move the waste to a liquid and power through a propeller stirring at a rate of 1000 RPM.

TABLE 5
Properties of crude oil KU-H, product treated with ionic liquid catalyst
based on Ni and Mo with a 30:1 molar ratio (500 ppm weight).

| Properties | | Product |
|---|---|---|
| Specific Gravity, ° API | | 20 |
| Viscosity, sCt | 25° C. | 48.09 |
| | 40° C. | 28.48 |
| | 54.4° C. | 18.03 |
| Total sulfur, weight % | | 3.55 |
| Total Nitrogen, ppm weight | | 480 |
| SARA, % by weight | Saturates | 24.43 |
| | Polar | 14.39 |
| | Aromatic | 48.8 |
| | Asphaltenes | 9.62 |

TABLE 6
Properties of crude oil KU-H, product treated with ionic liquid catalyst
based on Ni and Mo with a 30:1 molar ratio (250 ppm weight).

| Properties | | Product |
|---|---|---|
| Specific Gravity, ° API | | 16 |
| Viscosity, sCt | 37.8° C. | 310 |
| | 40° C. | 260 |
| | 54.4° C. | 130 |
| Total sulfur, weight % | | 3.46 |
| Total Nitrogen, ppm weight | | 480 |
| SARA, % by weight | Saturates | 25.15 |
| | Polar | 13.13 |
| | Aromatic | 47.26 |
| | Asphaltenes | 9.69 |

With the agitation system was injected into 30 ml of ionic liquid catalyst with a Ni—Mo molar ratio 30:1 and adjusted the system pressure at 100 kg/cm² and a flow of hydrogen from 80 lt/hr. Increased the temperature to 400 ° C. at a rate of 100° C./h. Maintaining the reaction system under these conditions for 4 hours, after which they proceeded to the rapid cooling of the reactor by applying a current of air to the outer surface. The product is discharged from the bottom of the reactor and practice for physical and chemical analysis.

For loads and products gravity API according to methods ASTM-D-287 was determined, also, was moderate the kinematic viscosity according to method ASTM-D-445. The sulfur measurement took place according to method ASTM-D-4294. Total nitrogen using the method ASTM-D-4629. The content of aromatic asphaltenes, insoluble resins and in heptane was determined with ASTM-D-4124.

In Table 7 presents the results of the analysis for the product. In all cases the product properties were better with respect to the load, the specific gravity and viscosity decreased significantly, so the product is liquid at ambient conditions and no solid cargo.

Distillation indicates that between 50 and 70% of the hydrocarbons in the waste were converted into lighter distillates. Of those between 10 and 15% are located in the boiling range of gasoline between 30 and 40% in the fraction of diesel and the remaining fraction of diesel. The hydrogen content of the product was increased in all cases resulting in 10 and 20% higher than the hydrogen content of the load. The sulfur content decreased by 30%, indicating the presence of reactions of hydrodesulfurization, to a lesser degree than those observed in heterogeneous systems, where the degree of desulphurization is around 80%. The analysis reveals that families of hydrocarbon material asphaltene decreased significantly, approximately 80% of the loads of asphaltenes were converted into lighter hydrocarbons, particularly saturated and aromatic hydrocarbons, which increased its focus on 70 and 40% respectively. Polar hydrocarbons also became lighter hydrocarbons and natural aromatic or saturated, about 50% of polar material was transformed.

TABLE 7
Properties of Heavy Vacuum Residue (load) and hydrotreated product
with the ionic liquid catalyst based on Ni—Mo with a 30:1 molar ratio
(800 ppm weight).

| Properties | | Loading | Product |
|---|---|---|---|
| Specific Gravity, ° API | | 3 | 16.4 |
| Viscosity, sCt | 15.6° C. | n/a | 270.21 |
| | 25° C. | n/a | 157.05 |
| | 37.8° C. | n/a | 76.58 |
| Total sulfur, weight % | | 4.64 | 3.26 |
| Total Nitrogen, ppm weight | | 4780 | 3814 |
| Insoluble in n-Heptane | | 20.87 | 13.45 |
| SARA, % by weight | Saturates | 13.16 | 25.44 |
| | Polar | 24.48 | 15.27 |
| | Aromatic | 25.64 | 36.64 |
| | Asphaltenes | 36.72 | 22.65 |

n/a not analyzed

### Example 7

In a Parr reactor with a capacity of 1800 ml, 1000 g was loaded heavy vacuum residue, whose properties are listed in Table 7. The reactor was pressured to 20 Kg/cm² with hydrogen and heated to 90° C. in order to move the waste to a liquid and power through a propeller stirring at a rate of 1000 RPM. With the agitation system was injected into 20 ml of catalyst was adjusted and the system pressure at 100 kg/cm² and a flow of hydrogen from 80 lt/hr. Increased the temperature to 400° C. at a rate of 100° C./h. Maintaining the reaction system under these conditions for 4 hours, after which they proceeded to the rapid cooling of the reactor by applying a current of air to the outer surface. The results of the product are shown in Table 8.

TABLE 8
Properties of the residual vacuum hydrotreated heavy catalyst with ionic
liquid-based Ni—Mo with a 30:1 molar ratio (800 ppm weight).

| Properties | | Product |
|---|---|---|
| Specific Gravity, ° API | | 17 |
| Viscosity, sCt | 15.6° C. | 1399 |
| | 25° C. | 601.2 |
| | 37.8° C. | 240.18 |
| Total sulfur, weight % | | 3.76 |
| Total Nitrogen, ppm weight | | 0.47 |
| Carbon, % by weight | | 85.05 |
| Hydrogen, % by weight | | 10.47 |
| Oxygen, % by weight | | 0.25 |
| SARA, % by weight | Saturates | 29.27 |
| | Polar | 14.41 |
| | Aromatic | 41.13 |
| | Asphaltenes | 15.19 |

### Example 8

In a Parr reactor with a capacity of 1800 ml, 1000 g was loaded heavy vacuum residue, whose properties are listed in Table 7. The reactor was pressured to 20 Kg/cm² with hydrogen and heated to 90° C. in order to move the waste liquid and power through a propeller stirring at a rate of 1000 RPM. With the agitation system was injected into 20 ml of catalyst was adjusted and the system pressure at 100 kg/cm² and a flow of hydrogen from 80 lt/hr. Increased the temperature to 395° C. at a rate of 100° C./h. Maintaining the reaction system under these conditions for 3 hours, after which they proceeded to the rapid cooling of the reactor by applying a current of air to the outer surface. The results of the product are shown in Table 9.

TABLE 9
Properties of the residual vacuum hydrotreated heavy catalyst with ionic
liquid-based Ni—Mo with a molar ratio 30:1 (800 ppm weight).

| Properties | | Product |
|---|---|---|
| Specific Gravity, ° API | | 15 |
| Viscosity, sCt | 15.6° C. | 1400 |
| | 25° C. | 650 |
| | 37.8° C. | 295 |
| Total Nitrogen, ppm weight | | 2.5 |
| Total Nitrogen, ppm weight | | 0.46 |
| Carbon, % by weight | | 86.01 |
| Hydrogen, % by weight | | 10.83 |
| Oxygen, % by weight | | 0.17 |
| SARA, % by weight | Saturates | 26.91 |
| | Polar | 16.58 |
| | Aromatic | 40.79 |
| | Asphaltenes | 15.72 |

### Example 8

In a Parr reactor with a capacity of 1800 ml, 1000 g was loaded heavy vacuum residue, whose properties are listed in Table 7. The reactor was pressured to 20 Kg/cm² with hydrogen and heated to 90° C. in order to move the waste liquid and power through a propeller stirring at a rate of 1000 RPM. With the agitation system was injected into 20 ml of catalyst was adjusted and the system pressure at 100 kg/cm² and a flow of hydrogen from 80 lt/hr. Increased the temperature to 395° C. at a rate of 100° C./h. Maintaining the reaction system under these conditions for 3 hours, after which they proceeded to the rapid cooling of the reactor by applying a current of air to the outer surface. The results of the product are shown in Table 9.

TABLE 9
Properties of the residual vacuum hydrotreated heavy catalyst with ionic
liquid-based Ni—Mo with a molar ratio 30:1 (800 ppm weight).

| Properties | | Product |
|---|---|---|
| Specific Gravity, ° API | | 13 |
| Viscosity, sCt | 15.6° C. | 1700 |
| | 25° C. | 780 |
| | 37.8° C. | 350 |
| Total sulfur, weight % | | 4.1 |
| Total Nitrogen, ppm weight | | 0.4.7 |
| Carbon, % by weight | | 85.9 |
| Hydrogen, % by weight | | 9.81 |
| Oxygen, % by weight | | 0.19 |
| SARA, % by weight | Saturates | 13.1 |
| | Polar | 17.4 |
| | Aromatic | 43.51 |
| | Asphaltenes | 26 |

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An ionic liquid catalyst for improving the properties of heavy crude oil and heavy vacuum residue, comprising metals of Group VIB and VIIIB of the periodic table.

2. The ionic liquid catalyst of claim 1, wherein said Group VIB and Group VIIIB metals are selected from Co, Zr, Ni, Mo, Fe, Ni and Mo.

3. The ionic liquid catalyst of claim 2, wherein said metals are Ni and Mo in a molar ratio of 30:1 in homogeneous phase with the oil phase and do not require activation.

4. The ionic liquid catalyst of claim 1, wherein said catalyst is prepared by admixing a metal precursor with an inorganic acid at a temperature between 15 and 80° C. to form a clear solution, and thereafter adding sufficient water to obtain a water to precursor ratio of between 1:1 and 1:0.4.

5. A method for the conversion of a heavy crude oil or vacuum residue, which comprises admixing an ionic liquid catalyst comprising Group VIB and Group VIIIB metals of the periodic table in liquid phase with a heavy crude oil or vacuum residue feed to form a homogeneous mixture under temperature and pressure conditions to form a hydrocarbon product comprising increased amounts of hydrocarbon distillate.

6. The method of claim 5, wherein said ionic liquid catalyst is: a) admixed in liquid phase with said feed at a concentration of 10-5000 ppm by weight of said catalyst in relation to said feed, b) formed into a homogeneous mixture, c) pressurized with hydrogen to at least 50 Kg/cm², d) subjected to an increased temperature in the range of 250-420° C. for a residence time of reaction of from 1 to 20 hours, and electively forming a hydrocarbon product comprising gasoline and diesel fractions by disintegration reactions of resins and asphaltenes.

7. The method of claim 6, wherein said hydrogen pressure is in the range of 50 to 150 Kg/cm².

8. The method of claim 6, wherein the concentration of said ionic liquid catalyst is between 100 and 1000 ppm by weight.

9. The method of claim 3, wherein said hydrocarbon product has an API gravity of at least 10 units greater than said feed.

10. The method of claim 3, wherein the distillable fraction of said heavy crude oil and vacuum residue feed is increased to at least 50 wt % gasoline, diesel and gas oils.

11. The method of claim 3, wherein the concentration of asphaltenes in the heavy crude oil and heavy vacuum residue feed is reduced up to 54 wt %.

12. The method of claim 3, wherein 30 wt % of the sulfur content in heavy crude oil and heavy vacuum residue are eliminated.

13. The method of claim 3, wherein viscosity of the product of the residual vacuum is liquid at ambient conditions, yielding values of 76.58 cSt viscosity of up to 37.8° C.

14. The method of claim 3, wherein said Group VIIIB metal and said Group VIB are present in said catalyst in a 30:1 molar ratio.
